(19) United States
(12) Patent Application Publication
(10) Pub. No.: US 2006/0115346 A1
(43) Pub. Date: Jun. 1, 2006

(54) Easily operated nail

(76) Inventor: Shu-Chung Huang, Kao Hsiung (TW)

Correspondence Address: SHU-CHUNG HUANG, 235 Chung-Ho, Box 8-24, Taipei, TW

(21) Appl. No.: 10/998,443

(22) Filed: Nov. 29, 2004

(51) Int. Cl. F16B 35/04

(52) U.S. Cl. 411/418

(57) ABSTRACT

An easily operated nail has a nail body. One end of the nail has a tip portion and another end thereof has a head portion, the tip being formed by metal. The tip portion of the nail body has a threaded portion; and the head portion of the nail has a driving portion. The threaded portion is made by extruding two sides of the nail body so that the metal material of the nail body deforms to form the threaded portion. The threaded portion is near the head portion of the nail body. The driving portion is one of a concave cruciform slot, a concave straight slot, a concave polygonal recess, a convex cruciform protrusion, a concave straight protrusion, and a convex polygonal protrusion. The metal is one of iron and steel.

### FIELD OF THE INVENTION

The present invention relates to nails, and in particular an easily operated nail, which can be beaten into or pull out from a material easily.

### BACKGROUND OF THE INVENTION

Currently, for reuse of waste materials, it is required to pull nails. Referring to FIGS. 1 and 2, it is illustrated that the prior art nail 10 is mainly formed by a nail body 11. One end of the nail body 11 has a tip portion 12 and another end thereof has a head portion 13. In use, an impact force is applied to the head portion 13 so that the tip portion 12 is beaten into a wood.

However the head portion 13 is embedded into the wooden. Currently, the operation of beating nails is formed by electric nail drivers so that the nail is beaten into the wood deeply, as shown in FIG. 2. As a result it is very difficult to pull the nail out of the wood.

### SUMMARY OF THE INVENTION

Accordingly, the primary object of the present invention is to provide an easily operated nail, which can be beaten into or pull out from a material easily.

To achieve above objects, the present invention provides an easily operated nail, wherein the nail has a nail body. One end of the nail has a tip portion and another end thereof has a head portion, the tip being formed by metal. The tip portion of the nail body has a threaded portion; and the head portion of the nail has a driving portion. The threaded portion is made by extruding two sides of the nail body so that the metal material of the nail body deforms to form the threaded portion. The threaded portion is near the head portion of the nail body. The driving portion is one of a concave cruciform slot, a concave straight slot, a concave polygonal recess, a convex cruciform protrusion, a concave straight protrusion, and a convex polygonal protrusion. The metal is one of iron and steel.

The various objects and advantages of the present invention will be more readily understood from the following detailed description when read in conjunction with the appended drawing.

### BRIEF DESCRIPTION OF THE DRAWINGS

FIG. 1 is a perspective view of the prior art nail.

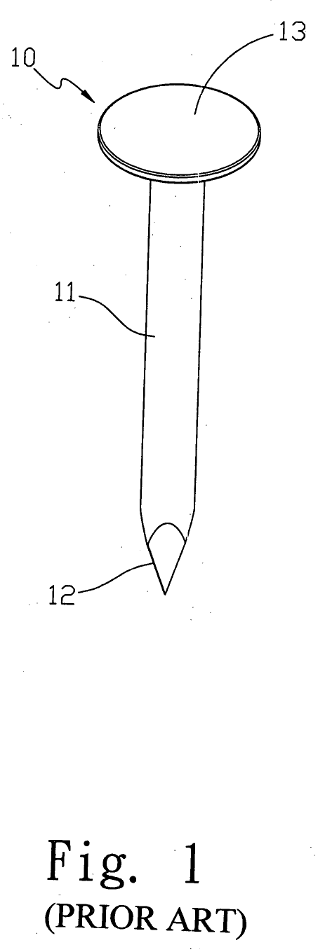

FIG. 2 is a schematic view of the prior art nail.

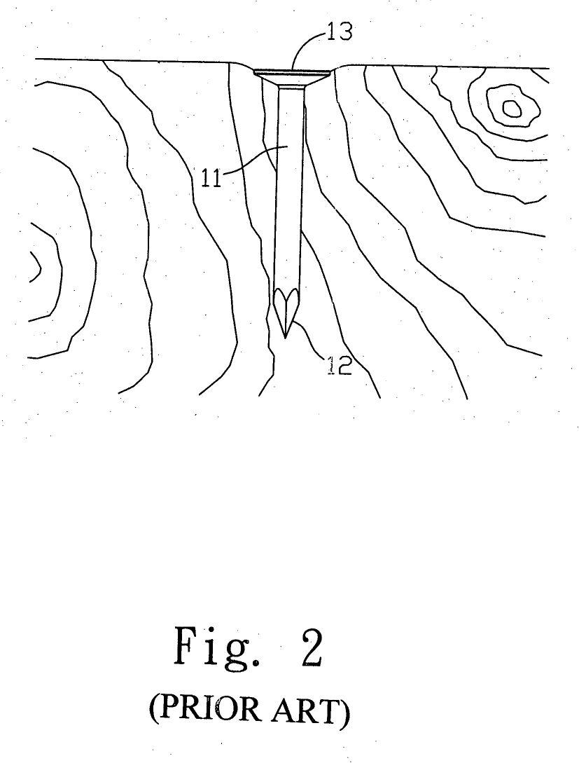

FIG. 3 is a perspective view of the present invention.

FIG. 4 is a schematic view showing the use of the present invention.

FIG. 5 is a perspective view of another embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

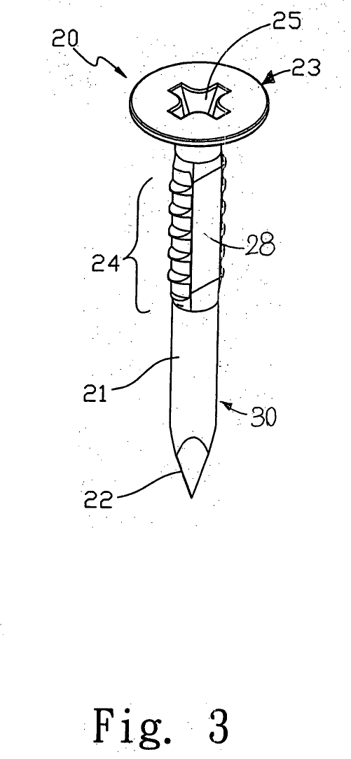

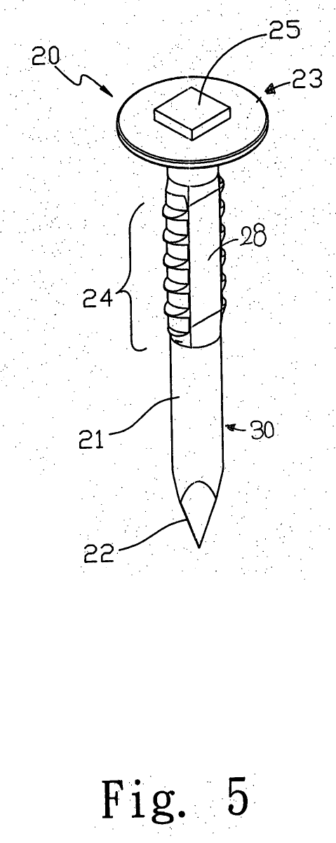

Referring to FIGS. 3 and 5, the structure of the present invention is illustrated.

In FIG. 3, it is shown that the nail 20 of the present invention is made of metal material (for example, irons or steel). The nail 20 has a nail body 21. One end of the nail 20 has a tip portion 22 and another end thereof has a head portion 23. The tip portion 22 and the head portion 23 are same as those in the prior arts and thus the details will not be described herein.

The feature of the present invention is that the tip portion of the nail body 21 has a threaded portion 24. The head portion 23 of the nail 20 has a driving portion 25.

The threaded portion 24 is made by extruding two sides of the nail body 21 so that the metal material of the nail body 21 deforms to form the threaded portion 24.

It is preferable that the threaded portion 24 is near the head portion 23 of the nail body 21.

The driving portion 25 is a concave cruciform slot or a concave straight slot, or a concave polygonal recess, or a convex cruciform protrusion, or a concave straight protrusion, or a convex polygonal protrusion, as shown in FIG. 5.

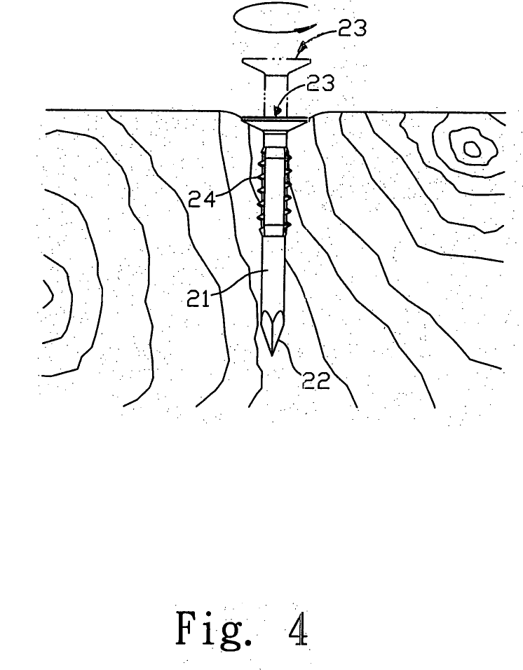

In use of the nail 20 of the present invention, as the prior art nail, the head portion 23 can be impacted by a nail driver so that the tip portion 22 will impinge into a wooden material. Thus, the nail 20 is beaten into the wooden material. Then when it is desired to pull the nail 20 out, as shown in FIG. 4, a rotating means can be engaged to the driving portion 25. Then, the nail body 21 is driven to rotate. Then the nail body 21 will retract along the threaded portion 24 so that the head portion 23 protrudes out of the wooden surface. Then the nail body 21 can be pull out.

Thereby the present invention provides a structure so that the nail can be beaten into or detached from a material easily.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1-5. (canceled)

6. An easily operated nail comprising:
a nail body formed by metal, the nail body comprising:
a tip portion;
a threaded portion; the threaded portion containing all threads on the nail and all spaces between the threads: and the threaded portion having at least one flat surface without threads, any flat surface being not connected to another flat surface;
a non-threaded portion; and
a head portion being a driving portion for engaging a tool for driving the nail; and
wherein the head portion being near the threaded portion and the non-threaded portion is located between the threaded portion and the tip portion;
wherein the non-threaded portion is directly connected to the tip portion; and no thread is formed on the non-threaded portion and the tip portion.

7. The easily operated nail as claimed in claim 1, wherein there are two flat surfaces at the threaded portion of the tip portion.

8. The easily operated nail as claimed in claim 1, wherein the driving portion is one of a concave cruciform slot, a concave straight slot, a concave polygonal recess, a convex cruciform protrusion, a concave straight protrusion, and a convex polygonal protrusion.

9. The easily operated easily operated nail as claimed in claim 1, wherein the metal is one of iron and steel.
